(19) United States
(12) Patent Application Publication
(10) Pub. No.: US 2008/0222504 A1
(43) Pub. Date: Sep. 11, 2008

(54) SCRIPT-BASED SYSTEM TO PERFORM DYNAMIC UPDATES TO RICH MEDIA CONTENT AND SERVICES

(75) Inventor: Suresh Chitturi, Plano, TX (US)

Correspondence Address: FOLEY & LARDNER LLP, P.O. BOX 80278, SAN DIEGO, CA, 92138-0278, US

(73) Assignee: Nokia Corporation

(21) Appl. No.: 12/036,991

(22) Filed: Feb. 25, 2008

Related U.S. Application Data
(60) Provisional application No. 60/891,646, filed on Feb. 26, 2007.

(51) Int. Cl. G06F 17/00; G06F 15/16

(52) U.S. Cl. 715/201; 709/219

(57) ABSTRACT

A system and method is provided for delivering content to a client device including at least one script without at least one of embedding the at least one script within a web page and referencing the at least one script from the web page. A signal is transmitted to a client device, the signal carrying within a packet stream, a multimedia presentation specified using a markup language and comprised of at least a single data unit. The single data unit includes at least one of a scene content and a scene update, the scene update including at least one of a scene command and a script fragment.

### FIELD OF THE INVENTION

The present invention relates generally to rich media content and services. More particularly, the present invention relates to delivering dynamic updates to rich media presentation content to remote terminals exclusively through script fragments.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Recently, mobile device capabilities have been increasing at a rapid pace, e.g., increased processing power, larger screen displays, and improved digital services. As a result, consumer demand for rich multimedia content and applications, such as on-demand services that can be delivered every where at all times has also increased. Rich media content can generally be referred to as content that is graphically rich and contains compound/multiple media including graphics, text, video and/or audio. In addition, rich media can dynamically change over time and can respond to user interaction, while being delivered through a single interface.

Rich media applications, particularly in the Web services domain, can include Extensible Markup Language (XML)-based content, such as, for example, Scalable Vector Graphics Tiny (SVGT) 1.2. SVGT 1.2 refers to a language for describing two-dimensional graphics in XML. SVG can allow for three types of graphic objects: vector graphic shapes (e.g., paths consisting of straight lines and curves); multimedia (such as raster images, video, video); and text. SVG drawings can also be interactive (using a Document Object Model (DOM) event model) as well as dynamic. SVG animations can be defined and triggered either declaratively (e.g., by embedding SVG animation elements in SVG content) or via scripting, where scripting can refer to the use of scripting languages that are generally interpreted and can, for example, be typed directly from a keyboard. This is in contrast to programs that are converted into binary executable files, scripts can remain in their original form and can be interpreted command-by-command each time they are run. Sophisticated applications of SVG are possible through the use of a supplemental scripting language that accesses the SVG Micro Document Object Model (uDOM), thereby providing complete access to all elements, attributes and properties of the SVG content. Furthermore, a rich set of event handlers can be assigned to any SVG graphical object.

Hypertext Markup Language (HTML)/Extensible Hypertext Markup Language (XHTML) is the standard XML language used by all web browsers operating today. HTML/XHTML provides a technique of describing the layout, style information, and structure of text content along with the ability to embed media objects for multimedia presentations. HTML/XHTML can also include embedded scripts to offer interactivity within the web content.

In addition, the Compound Documents Format (CDF) working group is producing recommendations for a CDF language that combines separate component languages, e.g., XML-based languages, elements, and attributes from separate vocabularies, such as XHTML, SVG, Mathematical Markup Language (MathML), and Synchronized Multimedia Integration Language (SMIL), with a focus on user interface markups. When combining user interface markups, specific problems need to be resolved that are not addressed by the individual markup specifications. These problems can include the propagation of events across markups, the combination of rendering, and/or a user interaction model with a combined document. The CDF working group seeks to address these types of problems by dividing the issues into phases and into two technical solutions, e.g., combining by reference and combining by inclusion. Because of its compatibility, CDF can leverage features such as scripting, which can be applied to both XHTML and SVG elements simultaneously within the same Web page.

However, despite broad support for scripting in mobile web content and platforms, there is currently no support for a standard mechanism at the system level to deliver scripts to a terminal independently of the web or scene content. In other words, conventional systems require that the scripts are always embedded within or referenced from a web page in order to utilize and execute the scripts. In addition, the scripts cannot ve sent independently at a later time. It should be noted that within these conventional systems, content within the script element is considered executable, and is either in the form of textual content (such as ECMAScript or Python) or compiled code (such as a JAVA JAR file).

This issue of not being able to deliver scripts independently of the web or scene content is experienced by almost all of the web services available today regardless of the underlying protocol(s) used to deliver the scripts, e.g., Hypertext Transfer Protocol (HTTP) and Realtime Transport Protocol (RTP)/User Datagram Protocol (UDP). More particularly, the problem is severe in the case of broadcast services, where a content provider may desire to push or broadcast scripts to update a web page (or scene content) without wanting to rely on a client to establish a connection and send a new request for content. In addition, the problem can be severe in situations, where the client has full control and only tunes into a stream when it wishes to receive content. This is in contrast to a client that establishes a point-to-point connection and always maintains this connection with the server to receive updates.

Therefore, a need exists for a language model that supports the delivery of scenes and updates in the form of complete script fragments that can be applied to the scenes. In addition, a need exists for a signalling mechanism at the transport layer that allows scripts to be applied to an original scene as a viable alternative to update commands. Furthermore, a client-side model that interprets scripts and applies them to a scene based on a particular time or event instance is also needed.

There are ongoing efforts in two standards bodies, namely Moving Pictures Experts Group (MPEG)-Lightweight Application Scene Representation (LASeR) working group and the 3^{rd} Generation Partnership Project (3GPP)-Dynamic and Interactive Multimedia Scenes (DIMS) working group, which seek to specify a mechanism to update scene content remotely from a server with the use of commands that includes several operations, such as insert, delete, replace, and add. These commands can be considered to be declarative in nature, and upon reception, can modify graphical objects in a scene accordingly. The MPEG-LASeR and 3GPP-DIMS standards also address the notion of a media sample or data unit that may contain either a scene or a scene update command, as well as appropriate transport mechanisms to carry these samples over multiple bearers, such as Mobile Broadcast Multicast Service (MBMS), Packet Switched Streaming (PSS), and HTTP. However, these standards employ techniques that are purely dedicated and limited to command-based syntax for updates. In addition, these standards do not address the possibility of exclusively carrying procedural code, such as scripts to perform the updates.

In addition to the ongoing work regarding the standards described above, U.S. Patent Publication No. 2005/0102611, entitled “Process for creating dynamic web pages driven from the server side” (hereinafter referred to as “the '611 publication”) defines a process for creating server-driven dynamic web content without the use of browser add-ins or plug-in programs. According to the '611 publication, rather than relying on a plug-in on the browser side, a server uses an independent and persistent HTTP connection to stream commands to a browser that results in dynamic updates of a displayed web page. When a browser requests a page that will be dynamically updated from the server side, the server sends an HTTP reply that results in the browser making at least two HTTP requests. The first request results in the server providing a display page, while the second request establishes an independent HTTP connection that serves as a control stream for the server to send commands to the browser. The commands are then implemented through the DOM of the browser and result in the dynamic updating of the display page. Therefore, the '611 publication focuses primarily on HTTP, and is based on a client-pull mechanism where the client makes an HTTP connection with the server that is kept persistently open to retrieve any update commands. It fails, however, to address the problem of delivering updates during mobile broadcast scenarios such as MBMS, and Digital Video Broadcasting-Handheld (DVB-H), where the stream is broadcast and the client requires an explicit connection to the server.

European Patent Application No. EP 1688849 entitled, “A method for performing a dynamic update of composed web services” (hereinafter referred to as “the '849 application”) presents a method for performing a dynamic update of at least one composed web service within a web service environment. The composed web service relies on a set of component services which are linked to at least one goal of the composed service. The method itself involves: publishing the at least one goal within a registry of the web service environment; storing the links between the component services and the at least one goal in the registry; and updating the links dynamically in case any service change within the web service environment occurs. The '849 application further contemplates a computer system, program product, and computer-readable medium for performing dynamic updates of composed web services within a web service environment, where an association storage is part of a web service environment. Therefore, the '849 application is very specific to web services and deals with dynamic updates to service oriented architecture, but does not solve the problem of mobile broadcasts of rich media content and services.

### SUMMARY OF THE INVENTION

Various embodiments of the present invention provide a system and method for delivering content to a client device including at least one script without at least one of embedding the at least one script within a web page and referencing the at least one script from the web page. A signal is transmitted to a client device, the signal carrying within a packet stream, a multimedia presentation specified using a markup language and comprised of at least a single data unit. The single data unit includes at least one of a scene content and a scene update, the scene update including at least one of a scene command and a script fragment.

In addition, various embodiments of the present invention provide a framework for service providers to make exclusive use of scripts to perform scene updates as opposed to conventional solutions that only require the scene update syntax, which is a command-based approach. It should be noted that various embodiments of the present invention can also be considered to be a complement to existing command-based solutions, as well a complete replacement. In addition, various embodiments of the present application allow for extensibility. In other words, a service can be created using any type of scripting language offering more choice (e.g., EcmaScript, Python, or JAVA JAR files). Signalling mechanisms are also provided in a Data unit header to identify the boundaries of scene and scene update content within a Data unit body, thus enabling quick look-up and fast processing of the content at the client side.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 shows a generic multimedia communications system for use with the present invention;

FIG. 2 is a perspective view of a mobile telephone that can be used in the implementation of the present invention;

FIG. 3 is a schematic representation of the telephone circuitry of the mobile telephone of FIG. 2;

FIG. 4A illustrates a data unit package in accordance with one embodiment of the present invention;

FIG. 4B illustrates a data unit package in accordance with a second embodiment of the present invention;

FIG. 5A illustrates a data unit package in accordance with a third embodiment of the present invention;

FIG. 5B illustrates a data unit package in accordance with a fourth embodiment of the present invention; and

FIG. 6 shows an end-to-end system architecture for delivering rich media content and services in accordance with various embodiments of the present invention.

### DETAILED DESCRIPTION OF THE PREFERRED EMBODIMENTS

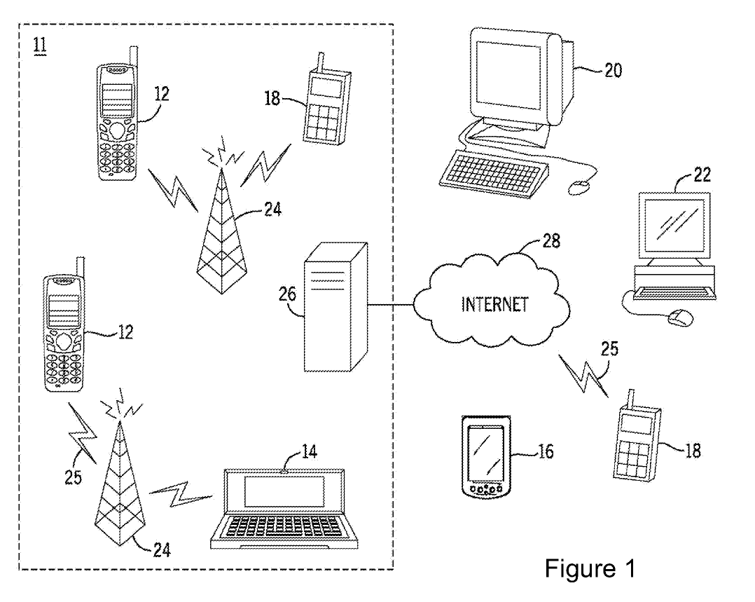

FIG. 1 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile device 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

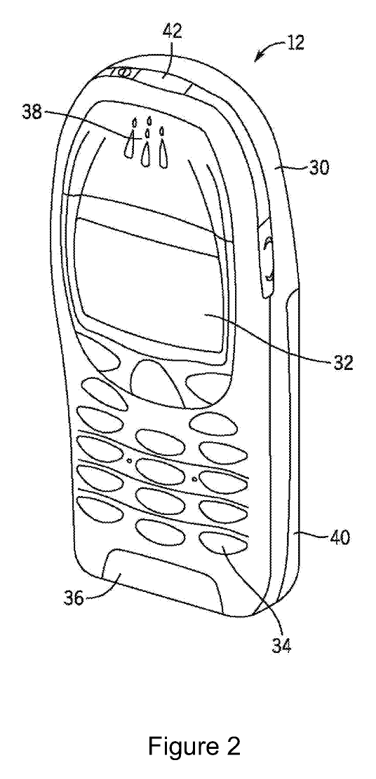

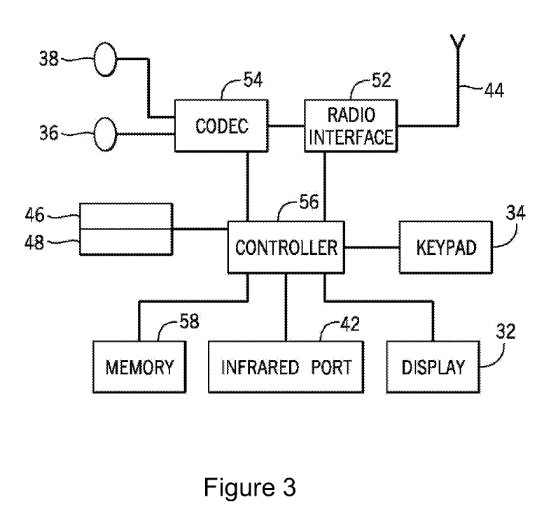

FIGS. 2 and 3 show one representative mobile device 12 within which the present invention may be implemented. It should be understood, however, that the present invention is not intended to be limited to one particular type of electronic device. The mobile device 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

Various embodiments of the present invention provide a system and method that enables delivery of dynamic updates for rich media presentations to remote terminals exclusively through script fragments. These script fragments not only provide procedural and/or programmable code execution, but can also operate on the XML-structured languages through predefined bindings to DOM Application Programming Interfaces (APIs). The combination of scripting and DOM APIs can offer rich interactivity to the structured presentation language through power manipulation of the document tree of DOM.

There are several scenarios where remote and dynamic script updates are crucial for delivering rich media services based on presentation languages such as HTML and SVG. Although SVG can support these applications as a presentation framework, SVG lacks the ability to dynamically update SVG content through remote scripts over a broadcast channel.

One such scenario where remote and data script updates are crucial occurs during the preview of long cartoon animations. Animation previewing is a service that allows an end-user to progressively download small script fragments that can present animated content in parts as opposed to downloading the entire animation at once.

Interactive Mobile TV services encompass another scenario where remote and data script updates are crucial. Interactive Mobile TV services are understood to have the ability to provide a deterministic rendering and behavior of rich-media content, including audio-video content, text, graphics, images, along with TV and radio channels, together in the end-user interface. Such a service must provide convenient navigation through content in a single application or service. In addition, it must allow synchronized interaction from local and/or distant locations, such as for voting and personalization applications (e.g., related menus or sub-menus, advertising, and content in relation to an end-user profile or service subscription). In this context, it is very important for a service provider to be able to control the user interface of an application remotely, which can be done by pushing a complete script fragment to be executed at a particular instant of time.

Live enterprise data feeds on the other hand, are services that include, for example, stock tickers that provide streaming of real-time quotes, live intra-day charts with technical indicators, news monitoring, weather alerts, charts, business updates, etc. Using scripts to manipulate this type of content can complement such services.

Live Chat services are yet another area where remote and data updates can be utilized. Such services can be incorporated within a web cam, a video channel, and/or a rich-media blog service. End-users can register, save their identification information, and exchange messages, where the messages appear dynamically in the live chat service along with rich-media data provided by the end-user. The live chat service can either be private or public in one or more multiple channels at the same time. End-users can be dynamically alerted of new messages from other users. It should be noted that dynamic updates of messages within the service can occur without reloading a complete page.

Karaoke service is still another service employing remote and data updates. Karaoke service can involve displaying a music TV channel or video clip catalog in conjunction with the lyrics of a song using fluid-like animation on the lyrics text characters to be sung (e.g., smooth color transition of fonts, scrolling of text). In addition, an end-user can download a song of his choice along with the complete animation by selecting an interactive button.

Rich media-based games are services geared towards entertainment that allow for multimedia content to be presented with some game logic using scripts for entertainment purposes. The position of a character within a game and the game model can be dynamically changed via script fragments pushed from the game server.

In the context of rich media applications as currently being specified in 3GPP-DIMS and Open Mobile Alliance-Rich Media Environment (OMA-RME), there exists a concept of media sample or data access unit that can be made up of either a scene which is a complete well-formed SVG document or a scene command that can be used to perform update operations to the original scene. It should be noted that a scene update/update operations can utilize one or more sets of differences that make changes to a scene in a current session. In addition, it is also possible to combine these samples, for example package scene and multiple scene updates, into a single package. These Data units may be used in normal processing or for the purpose of repair processing, where repair Data units can be marked/identified as random access points when they are necessary for them to function as Random Access Points (RAPs). Alternatively, the Data units can be marked as “repair” Data units to indicate that a particular Data unit can be used to repair the client in the case of tune-in scenario or for error-recovery purposes.

The following is an example of a sample dData unit containing a scene, followed by a declarative scene update, both of which are within a single sample/access unit. In this case, the scene fragment of the sample is parsed, initialized, and rendered on an appropriate display. Once the scene is processed, the scene update fragment is processed and applied to the current scene, where the syntax of a scene can be expressed as follows:

```
<svg id=”root” width=“12cm” height=“4cm” viewBox=“0 0 1200 400”
    xmlns=“http://www.w3.org/2000/svg” version=“1.2”
baseProfile=“tiny”>
  <desc>Example rect01 - rectangle with sharp corners</desc>
  <!-- Show outline of canvas using ‘rect’ element -->
  <rect x=“1” y=“1” width=“1198” height=“398”
      fill=“none” stroke=“blue” stroke-width=“2”/>
  <rect x=“400” y=“100” width=“400” height=“200”
      fill=“yellow” stroke=“navy” stroke-width=“10” />
</svg>
```

In turn, the syntax of a scene update (e.g., commands) can be expressed as follows:

```
<Insert ref=“root”>
  <g id=“myGroup” visibility=“hidden”/>
</Insert>
<Insert ref=“myGroup”>
  <rect id=“myRect” fill=“red” x=”10 y=”10” width=”50”
  height=”50” />
</Insert>
```

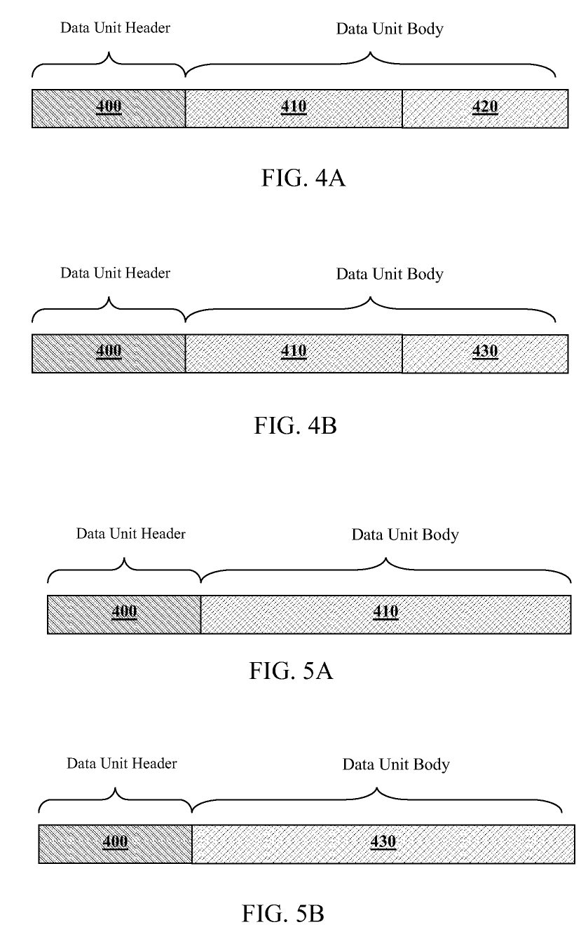

FIGS. 4 and 5 illustrate this concept of utilizing a single media sample/data unit to encompass a scene along with a scene update from the packaging or transport level perspective. A portion 400 of the sample/data unit shown in FIG. 4A can contain a media unit header, which can be thought of as the Data unit header. A portion 410 can contain a complete scene and a portion 420 can contain scene update information, e.g., one or more scene commands. The portions 410 and 420 can collectively be considered to be the Data unit body.

Various embodiments of the present invention extend this concept further, where updates to the scene are described exclusively through the use of procedural code or scripts (e.g., ECMAScript) instead of declarative content, which conceptually and technically results in the same DOM and visual representation of scene. The following example illustrates this extended concept by replacing the scene update commands in the above example with ECMAScript code. It should be noted that the ECMAScript uses calls to the DOM API through bindings. Such a technique offers more flexibility as updates can be designed with different scripting languages. In addition, a specialized parser to interpret the scene updates commands is not required, nor is the system limited to using one particular update syntax. The scene syntax according to various embodiments of the present invention can be expressed as follows:

```
<svg id=”root” width=“12cm” height=“4cm” viewBox=“0 0 1200 400”
    xmlns=“http://www.w3.org/2000/svg” version=“1.2”
baseProfile=“tiny”>
  <desc>Example rect01 - rectangle with sharp corners</desc>
  <!-- Show outline of canvas using ‘rect’ element -->
  <rect x=“1” y=“1” width=“1198” height=“398”
      fill=“none” stroke=“blue” stroke-width=“2”/>
  <rect x=“400” y=“100” width=“400” height=“200”
      fill=“yellow” stroke=“navy” stroke-width=“10” />
</svg>
```

In turn, a scene update, e.g., script fragments, can be expressed with the following syntax:

var root = document.getDocumetElement( ) ;
var myGroup = document.creatElementNS(http://www.w3.org/2000/svg,
”group”);
myGroup.setId(“myGroup”);
myGroup.setTrait(“visibility”, “hidden”);
root.appendChild(myGroup);
var myRect = document.creatElementNS(http://www.w3.org/2000/svg,
”rect”);
myRect.setId(“myRect”);
var color = root.createRGBColor( 255, 0, 0);
myRect.setRGBColorTrait(“fill”, color);
myRect.setFloatTrait(“x”, 10);
myRect.setFloatTrait(“y”, 10);
myRect.setFloatTrait(“width”, 50);
myRect.setFloatTrait(“width”, 10);
root.insertBefore(myRect, null);

Alternatively, the script fragments can be specified with XML notation using a <script type=”application/ecmascript> . . . </script>syntax where a scene can be expressed as follows:

```
<svg id=”root” width=“12cm” height=“4cm” viewBox=“0 0 1200 400”
    xmlns=“http://www.w3.org/2000/svg” version=“1.2”
baseProfile=“tiny”>
  <desc>Example rect01 - rectangle with sharp corners</desc>
  <!-- Show outline of canvas using ‘rect’ element -->
  <rect x=“1” y=“1” width=“1198” height=“398”
      fill=“none” stroke=“blue” stroke-width=“2”/>
  <rect x=“400” y=“100” width=“400” height=“200”
      fill=“yellow” stroke=“navy” stroke-width=“10” />
</svg>
```

In turn, script fragments can be described as follows:

<script type=”application/ecmascript>
var root = document.getDocumetElement( ) ;
var myGroup = document.creatElementNS(http://www.w3.org/2000/svg,
”group”);
myGroup.setId(“myGroup”);
myGroup.setTrait(“visibility”, “hidden”);
root.appendChild(myGroup);
var myRect = document.creatElementNS(http://www.w3.org/2000/svg,
”rect”);
myRect.setId(“myRect”);
var color = root.createRGBColor( 255, 0, 0);
myRect.setRGBColorTrait(“fill”, color);
myRect.setFloatTrait(“x”, 10);
myRect.setFloatTrait(“y”, 10);
myRect.setFloatTrait(“width”, 50);
myRect.setFloatTrait(“width”, 10);
root.insertBefore(myRect, null);
</script>

FIG. 4B illustrates various embodiments of the present invention, at the packaging or transport level, utilizing script fragments within the Data unit body to perform updates to the scene. A portion 400 can be a media unit header that can be considered to be the Data unit header. A portion 410 can be considered to be scene information. A portion 430 can be considered to be script fragments. The portions 410 and 430 can comprise the Data unit body. It should be noted that alternatively, it can be possible to only contain scene or scene updates, the scene updates comprising, for example, commands or script fragments, in the Data unit body. For example, FIG. 5A illustrates another embodiment of the present invention, where a portion 400 can be media unit header that can be considered to be the Data unit header. A portion 410 can be considered to be scene information, thus comprising the Data unit body. FIG. 5B illustrates yet another embodiment of the present invention, where a portion 400 can again, be a media unit header that can be considered to be the Data unit header. However, in contrast to the embodiment shown in FIG. 5A, a portion 430 can be considered to be script fragments comprising the Data unit body.

As described above, the Data unit contains a header to indicate whether the Data unit body is used for normal processing or for repair, to indicate priority (high or low), to indicate the compression used, or if the Data unit is to functions as a RAP for clients to tune-in or for error-recovery purposes. However, information regarding whether the Data unit contains only a scene, only a scene update, or a combination of scene and scene updates including the length of the particular type with the Data unit can aid in the processing of the Data unit. Such information can allow a receiving client to determine which parts of a Data unit need to be dispatched to a scene processor/manager or a scene update processor/manager. Therefore, various embodiments of the present invention allow for the signaling of this information for each Data unit in the Data unit Header as follows:

Data unit Header{
.....
Bits(2) data unit order;
Bits(1) scene update type;
BYTE(2) scene length;
BYTE(1) scene update length;
}

Of course, the Data unit Body can contain information regarding a scene, a scene update, or some combination thereof:

Data unit Body{
....
....
}

The data unit order can be a two bit indicator that denotes the order of data structure within the Data unit body. A ‘0’ can be used to indicate that only a scene is included within the body. A ‘1’ can indicate that only scene commands/updates are included within the body. A ‘2’ can indicate that a scene followed by a scene command/update is included in the body. A ‘3’ can indicate that a scene update/command followed by a scene is included in the body. It should be noted that the particular designations can be defined using alternative numbering schemes and more or less bits.

The scene update type can comprise a single bit indicator to denote the type of scene update present within the Data unit body, where a ‘0’ can indicate scene update commands, and a ‘1’ can indicate a script fragment. The scene length in turn, can comprise two bytes of information indicating the length of scene content within the Data unit body in network byte order. The scene update length can comprise a single byte of information indicating the length of scene update content within the Data unit body in network byte order. It should be noted that the particular designations can be defined using alternative numbering schemes and more or less bits and/or bytes.

Defining a structure in the above-described manner makes it possible to use scripts in all possible scenarios; particularly in the case of error-free normal processing and in the event of repair including tune-in and error-recovery. Scripts can also be used as RAPs, which when executed will enable the client to reach a stable state.

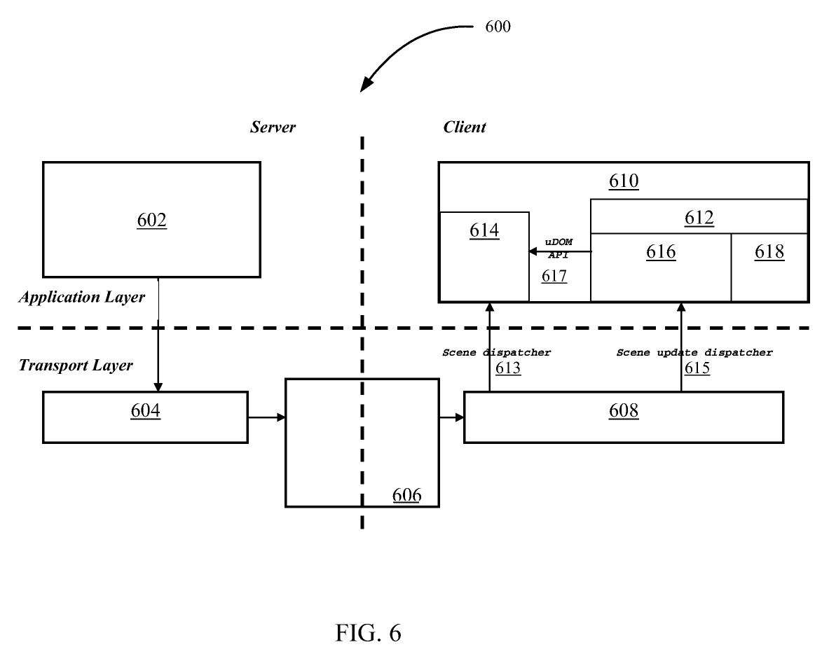

FIG. 6 illustrates a diagram presenting an end-to-end system architecture 600 for delivering rich media content and services showing the server/client, application layer, and transport layer perspectives in accordance with various embodiments of the present invention. A rich media content generation module 602 can generate, for example, scenes, scene update commands, and scripts which are transmitted from the server side application layer to a compression/packaging/RTP packetization module 604 in the server side transport layer. From the compression/packaging/RTP packetization module 604, the rich media content can be transmitted to a transport mechanisms module 606. The transport mechanisms module 606 can utilize various transmission mechanisms, including but not limited to, unicast, multicast, broadcast download, and streaming protocols.

The transport mechanisms module 606 can also function as the connection between the server and client sides of the system 600 by transmitting the rich media content to a decompression/de-packetization/unpackaging module 608 to the client side transport layer. The decompression/de-packetization/unpackaging module 608 sends the rich media content to a rich media client 610 in the client side application layer. Depending on whether the rich media content includes scene information and/or scene update information captured in one or more Data units, as described above, the decompression/de-packetization/unpackaging module 608 can utilize a scene dispatcher interface 613 and/or a scene update dispatcher interface 615. The scene dispatcher interface 613 can be used to transmit scene content to a scene manager 614, where the scene manager 614 can be a part of the rich media client 610. In other words, the scene dispatcher interface 613 is responsible for extracting and dispatching the scene content from the transport layer to the scene manager 614, which in turn is responsible for loading and displaying the scene content.

The scene update dispatcher interface 615 can be used to transmit scene update content to a scene update manager 612, where the scene update manager 612, in turn, can be a part of the rich media client 610 as well. That is, the scene update dispatcher interface 615 is responsible for extracting scene updates from the Data units in the transport layer and dispatching them to the scene update manager. As described above, there can be two types of scene updates, i.e., scene commands and script fragments. It can be the dispatcher's responsibility to indicate the appropriate type of scene update to the scene update manager 612 for managing the scene updates to ensure that they are applied to a scene at a given time or event instance. In addition to being responsible for managing the scene updates including parsing and applying the scene updates to the scene, the scene update manager 612 consists of a scene command processor 616 and a script engine 618 which are both used to perform dynamic updates to the scene content. In order to manipulate the scene content, a uDOM API Interface 617 is utilized. This is a common API available to and used by the scene update manager 612 to perform update operations to the scene. The update content can either be through the form of scene commands or script fragments, as described above.

Various embodiments of the present invention provide a framework for service providers to make exclusive use of scripts to perform scene updates as opposed to conventional solutions that only require the scene update syntax, which is a command-based approach. It should be noted that various embodiments of the present invention can also be considered to be a complement to existing command-based solutions, as well a complete replacement. In addition, various embodiments of the present application allow for extensibility. In other words, a service can be created using any type of scripting language offering more choice (e.g., EcmaScript, Python, or JAVA JAR files). Signalling mechanisms are also provided in the Data unit header to identify the boundaries of scene and scene update content within the Data unit body, thus enabling quick look-up and fast processing of the content at the client side.

The present invention is described in the general context of method steps, which may be implemented in one embodiment by a program product including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated. The features of the embodiments described herein may be combined in all possible combinations of methods, apparatus, computer program products and systems.

What is claimed is:

1. A method of delivering content including at least one script without at least one of embedding the at least one script within a web page and referencing the at least one script from the web page, comprising:
transmitting a signal, the signal carrying within a packet stream, a multimedia presentation specified using a markup language and comprised of at least a single data unit,
wherein the single data unit includes at least one of a scene content and a scene update, the scene update including at least one of at least one scene command and at least one script fragment.

2. The method of claim 1, further comprising transmitting the scene content to a scene manager of a client device via a scene dispatcher interface.

3. The method of claim 1, further comprising transmitting the scene update to a scene update manager of a client device via a scene update dispatcher interface.

4. The method of claim 1, further comprising manipulating the scene content utilizing the scene update via a micro document object model application programming interface.

5. The method of claim 1, wherein the at least one script fragment provides at least one of a procedural code execution, a programmable code execution, and an operation on an extensible markup language through predefined bindings to document object model application programming interfaces.

6. The method of claim 1, wherein the multimedia presentation is based upon at least one presentation language including at least one of a markup language and scalable vector graphics language.

7. The method of claim 1, wherein the multimedia presentation comprises at least one of an animation preview service, an interactive television service, a live enterprise data feed, a live chat service, a karaoke service, and a rich media-based game service.

8. The method of claim 1, wherein the at least one script fragment is specified utilizing one of ECMAscript code, Python code, Java code, Java Archive Files, and extensible markup language.

9. The method of claim 8, wherein a scripting language comprising one of ECMAscript code, Python code, Java code, Java Archive Files, and extensible markup language, is identified by a type string.

10. The method of claim 9, wherein the type string comprises an attribute of the at least one script fragment, and wherein executing the at least one script fragment updates the scene content.

11. The method of claim 1, wherein the single data unit comprises a header and a body.

12. The method of claim 11, wherein the header comprises at least one of a data set order indicator, a scene update type indicator, a scene length indicator, and a scene update length indicator.

13. The method of claim 12, wherein the scene update type indicator indicates whether the scene update comprises at least one of the at least one scene command and the at least one script fragment.

14. The method of claim 11, further comprising utilizing the header to determine portions of the single data unit to be dispatched to at least one of a scene manager and a scene update manager.

15. An apparatus, comprising:
a processor; and
a memory unit operatively connected to the processor and including:
computer code for transmitting a signal for delivering content including at least one script without at least one of embedding the at least one script within a web page and referencing the at least one script from the web page, the signal carrying within a packet stream, a multimedia presentation specified using a markup language and comprised of at least a single data unit,
wherein the single data unit includes at least one of a scene content and a scene update, the scene update including at least one of at least one scene command and at least one script fragment.

16. The apparatus of claim 15, wherein the memory unit further comprises computer code for transmitting the scene content to a scene manager of a client device via a scene dispatcher interface.

17. The apparatus of claim 15, wherein the memory unit further comprises computer code for transmitting the scene update to a scene update manager of a client device via a scene update dispatcher interface.

18. The apparatus of claim 15, wherein the memory unit further comprises computer code for manipulating the scene content utilizing the scene update via a micro document object model application programming interface.

19. The apparatus of claim 15, wherein the at least one script fragment provides at least one of a procedural code execution, a programmable code execution, and an operation on an extensible markup language through predefined bindings to document object model application programming interfaces.

20. The apparatus of claim 15, wherein the at least one script fragment is expressed with a scripting language identified by a type string.

21. The apparatus of claim 20, wherein the type string comprises an attribute of the at least one script fragment, and wherein executing the at least one script fragment updates the scene content.

22. The apparatus of claim 15, wherein the single data unit comprises a header and a body.

23. The apparatus of claim 22, wherein the header comprises at least one of a data set order indicator, a scene update type indicator, a scene length indicator, and a scene update length indicator.

24. The apparatus of claim 23, wherein the scene update type indicator indicates whether the scene update comprises at least one of the at least one scene command and the at least one script fragment.

25. A computer program product, embodied on a computer-readable medium, for delivering content including at least one script without at least one of embedding the at least one script within a web page and referencing the at least one script from the web page, comprising:
computer code for transmitting a signal, the signal carrying within a packet stream, a multimedia presentation specified using a markup language and comprised of at least a single data unit,
wherein the single data unit includes at least one of a scene content and a scene update, the scene update including at least one of at least one scene command and at least one script fragment.

26. The computer program product of claim 25, further comprising transmitting the scene content to a scene manager of the client device via a scene dispatcher interface.

27. The computer program product of claim 25, further comprising transmitting the scene update to a scene update manager of the client device via a scene update dispatcher interface.

28. The computer program product of claim 25, further comprising manipulating the scene content utilizing the scene update via a micro document object model application programming interface.

29. The computer program product of claim 25, wherein the at least one script fragment provides at least one of a procedural code execution, a programmable code execution, and an operation on an extensible markup language through predefined bindings to document object model application programming interfaces.

30. The computer program product of claim 25, wherein the at least one script fragment is expressed with a scripting language identified by a type string.

31. The computer program product of claim 30, wherein the type string comprises an attribute of the at least one script fragment, and wherein executing the at least one script fragments updates the scene content.

32. The computer program product of claim 25, wherein the single data unit comprises a header and a body.

33. The computer program product of claim 32, further comprising utilizing the header to determine portions of the data-set to be dispatched to at least one of a scene manager and a scene update manager.

34. A system, comprising:
a client device configured to receive content including at least one script without at least one of embedding the at least one script within a web page and referencing the at least one script from the web page;
a server configured to:
generate the content, the content further including at least one of scene content and at least one scene update; and
transmit a signal to a packaging module configured to at least one of compress, package, and packetize the content, the signal carrying within a packet stream, a multimedia presentation specified using a markup language and comprised of at least a single data unit, wherein the single data unit includes at least one of a scene content and a scene update, the scene update including at least one of at least one scene command and at least one script fragment;
a transport mechanisms module configured to receive the single data unit and transport the single data unit to a de-packaging module, the de-packaging module configured to at least one of decompress, de-packetize, and de-package the single data unit;
a scene dispatcher interface configured to transmit the scene content to a scene manager included within the client device;
a scene update dispatcher interface configured to transmit the scene update content to a scene update manager included within the client device, and manipulate the scene content via a micro document object model application programming interface.

35. The system of claim 34, wherein the single data unit comprises a header and a body.

36. The system of claim 35, wherein the header comprises at least one of a data set order indicator, a scene update type indicator, a scene length indicator, and a scene update length indicator.

37. The system of claim 36, wherein the scene update type indicator indicates whether the scene update comprises at least one of the at least one scene command and the at least one script fragment.

38. The system of claim 35, wherein the client device utilizes the header to determine portions of the single data unit to be dispatched to at least one of the scene manager and the scene update manager.

39. The system of claim 34, wherein the at least one script fragment is expressed with a scripting language identified by a type string.

40. The system of claim 39, wherein the type string comprises an attribute of the at least one script fragment, and wherein executing the at least one script fragment updates the scene content.
